(19) United States
(12) Patent Application Publication
(10) Pub. No.: US 2012/0110461 A1
(43) Pub. Date: May 3, 2012

(54) HEADLESS APPLIANCE

(76) Inventors: Adrian COWHAM, Fair Oaks, CA (US); Sherry Krell, Sacramento, CA (US); Serge Zelenov, Roseville, CA (US)

(21) Appl. No.: 12/916,383

(22) Filed: Oct. 29, 2010

(51) Int. Cl. G06F 3/01

(52) U.S. Cl. 715/736

(57) ABSTRACT

A headless appliance includes a network chassis management interface determiner configured to determine a network chassis management interface. The headless appliance is configured to be disposed in a network chassis. The headless appliance also includes a management interface command mapping configured to associate commands of the network chassis management interface to commands of a headless appliance management interface.

### BACKGROUND

Typically, a network chassis and a modular device, such as blade server, within the network chassis each include a management interface. A modular device management interface is very often dissimilar from the management interface in which the modular device is installed. In a case of such dissimilarity between the interfaces, a user of the network chassis must transition between the management interface of the network chassis and the management interfaces of the modular device.

### BRIEF DESCRIPTION OF THE DRAWINGS

FIGS. 1 and 2 illustrate examples of a network chassis and headless appliance, in accordance with embodiments of the present disclosure.

FIG. 3 illustrates an example of a CLI, in accordance with an embodiment of the present disclosure.

FIGS. 4 and 5 illustrate examples of a method for terminal emulation, in accordance with embodiments of the present disclosure.

The drawings referred to in this description should be understood as not being drawn to scale except if specifically noted.

### DESCRIPTION OF EMBODIMENTS

Reference will now be made in detail to embodiments of the present technology, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following description of embodiments, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

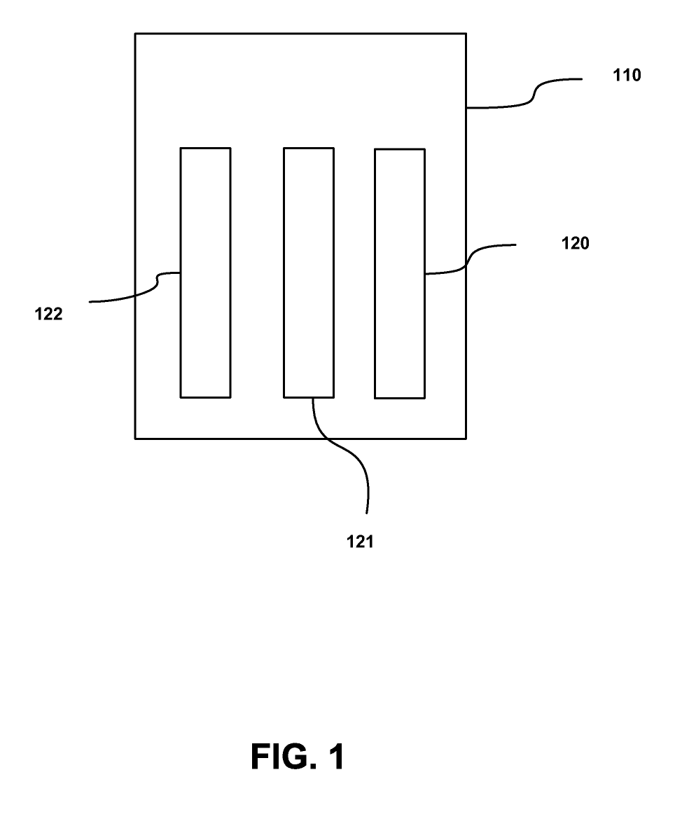

FIG. 1 depicts network chassis 110 and headless appliances 120-122 disposed within slots on network chassis 110. Network chassis 110 can be any network chassis that includes slots for modular network appliances. Network chassis 110 includes three slots for appliances, as depicted in FIG. 1. However, network chassis 110 can include any number of slots for modular network appliances.

Headless appliances 120-122 can be any headless modular network appliance, such as a blade server (e.g., x86 blade server), 10/100/1000 Ethernet port and the like. It should be appreciated that headless appliances 120-122 are appliances or modular network devices that do not include a video graphics array (VGA).

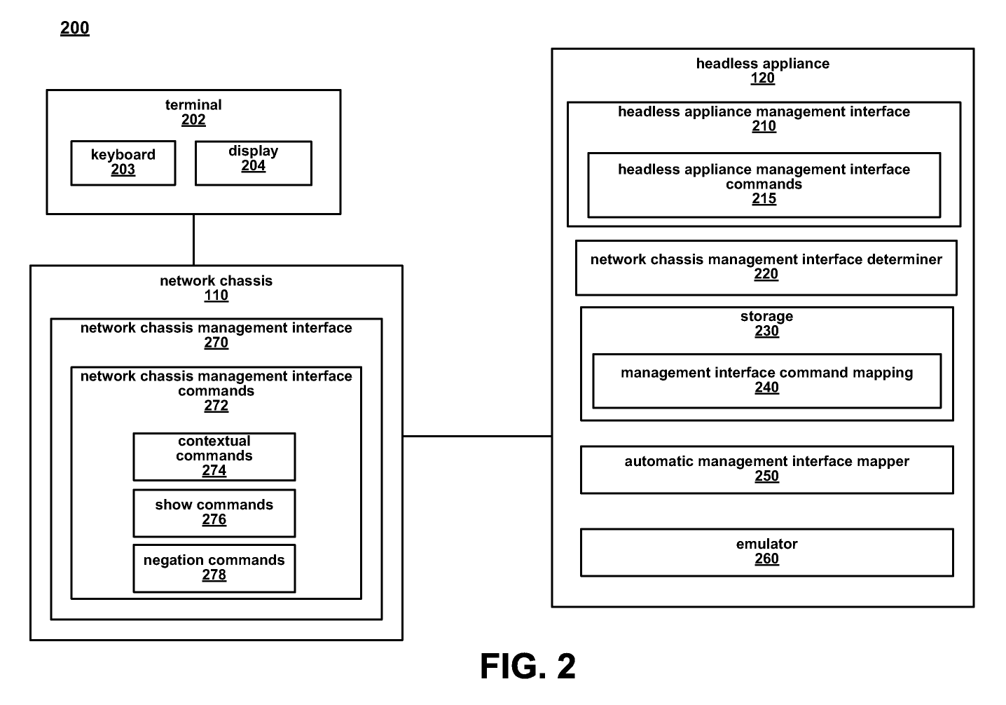

FIG. 2 depicts a functional layout of network chassis 110 and headless appliance 120, in accordance to an embodiment of the present disclosure. Terminal 202 is communicatively coupled to network chassis 110 such that a user (e.g., a network administrator) can control/monitor network chassis 110 and any modular network devices, such as headless appliance 120. Terminal 202 includes keyboard 203 and display 204.

Network chassis 110 includes network chassis management interface (NCMI) 270. For example, NCMI 270 may be a disk operating system (DOS) CLI, a unix-like CLI (e.g., a Linux CLI), a Hewlett-Packard (HP) networking device CLI (e.g. 5400zI switch), or any similar CLI.

NCMI 270 includes NCMI commands 272. NCMI commands 272 are any commands that are network specific commands (e.g., show ip) or any functionally related network commands (e.g., show tech). In various embodiments, NCMI commands 272 include contextual commands 274, show commands 276 and negation commands 278.

Contextual commands 274 are any commands that are associated with the interface context, or any other similar sub-context. When manipulating NCMI 270, a user may be first accustomed to first entering the context for the specific interface by issuing the appropriate command and then issuing contextual commands 274.

Show commands 276 are any commands that display or “show” information from a network device such as headless appliance 120. For example, a show ip command is used to display an Internet Protocol Address of a network device. Show commands 276 also include, but are not limited to, show version, show logging, show tech and the like.

Negation commands 278 are any commands that negate a previously issued command or turn off a feature of networking device by utilizing the prefix “no”. Examples of negation commands 278 are no ip, no logging, etc.

Headless appliance 120 is housed within and is communicatively coupled to network chassis 110. Headless appliance 120 includes headless appliance management interface (HAMI) 210, network chassis management interface determiner (NCMID) 220, management interface command mapping (MICM) 240 located in storage 230, automatic management interface mapper (AMIM) 250, and emulator 260, all of which will be described in detail below.

HAMI 210 is dissimilar to NCMI 270. For example, HAMI 210 is a graphical user interface (GUI) for a Microsoft Windows operating system.

Accordingly, at least some of HAMI commands 215 are dissimilar to NCMI commands 272. For example, a show ip command of NCMI commands 272 has an analog ipconfig command associated with HAMI commands 215. Although, the two commands are analogs they are dissimilar in syntax. It is appreciated that commands may be dissimilar in other ways besides syntax. For example, it is possible that commands with similar syntax cause their respective management interfaces to accomplish different actions.

In convention devices, the dissimilarity between NCMI 270 and HAMI 210, in particular, the dissimilarity between HAMI commands 215 and NCMI commands 272, forces a user to transition between NCMI 270 and HAMI 210. As a result, network administrators must operate network chassis 110 via NCMI 270 and operate headless appliance 120 via HAMI 210, which decreases productivity.

Unlike conventional devices, headless appliance 120 allows for network administrators to seamlessly transition between operating network chassis 110 and headless appliance 120. In particular, headless appliance 120 allows all the behaviors of NCMI 270 (e.g., DOS CLI) to be preserved when NCMI 270 interfaces with Microsoft Windows OS of headless appliance 120, such that a network administrator experiences a seamless transition between network chassis 110 and headless appliance 120, which will be described in detail below.

NCMD 220 is configured to determine NCMI 270 of network chassis 110 when headless appliance 120 is disposed in network chassis 110. For example, NCMD 220 determines that NCMI 270 is a DOS CLI by pinging network chassis 110.

MICM 240 is configured to associate NCMI commands 272 to HAMI commands 215. In various embodiments, MICM 240 associates contextual commands 274, show commands 276 and negation commands 278 (and in some embodiments other commands) with analogous or related HAMI commands 215. For example, MICM 240 provides a mapping between show ip command associated with network chassis 110 with an analogous ipconfig command associated with headless appliance 120 having a Microsoft Windows OS. MICM 240 provides similar mappings between other analogous commands.

It should be appreciated that some NCMI commands 272 do not have a corresponding analogous or related command of HAMI command 215. As such, MICM 240 associates a single command of NCMI commands 272 with a plurality of HAMI commands 215. For example, MICM 240 provides a mapping between a show tech command associated with network chassis 110 with a plurality of HAMI commands 215.

In one embodiment, MICM 240 is preconfigured and stored in storage 230. In another embodiment, a plurality of mappings are preconfigured and stored in storage 230. For example, a mapping associated with a DOS CLI is preconfigured and stored in storage 230 and a mapping associated with a Linux CLI is preconfigured and stored in storage 230. Accordingly, if a DOS CLI is determined by NCMID 220, then MICM 240 preconfigured for a DOS CLI is utilized by headless appliance 120, which will be described in detail below.

In some embodiments, AMIM 250 is configured to automatically generate MICM 240, when headless appliance 120 does not include a preconfigured MICM 240 associated with a determined NCMI 270. For example, AMIM 250 automatically generates a mapping of NCMI commands 272 to HAMI commands 215. For example, AMIM 250 automatically generates contextual commands 274, show commands 276 and negation commands 278 with analogous or related HAMI commands 215.

AMIM 250 has to be aware of semantics and syntax of NCMI commands 272 and HAMI commands 215. For example, AMIM 250 has to be aware of DOS CLI semantics and syntax associated with network chassis 110 and Microsoft Windows OS semantics and syntax associated with headless appliance 120.

In general, emulator 260 is configured to emulate the look and feel of NCMI 270. As a result, there is sense of cohesion between network chassis 110 and headless appliance 120 when a network administrator controls both network chassis 110 and headless appliance 120 via terminal 202. Moreover, a network administrator whose expertise is typically with NCMI 270 has little or no learning curve when controlling headless appliance 120.

In particular, emulator 260 emulates NCMI commands 272 by executing HAMI commands 215 based on MICM 240.

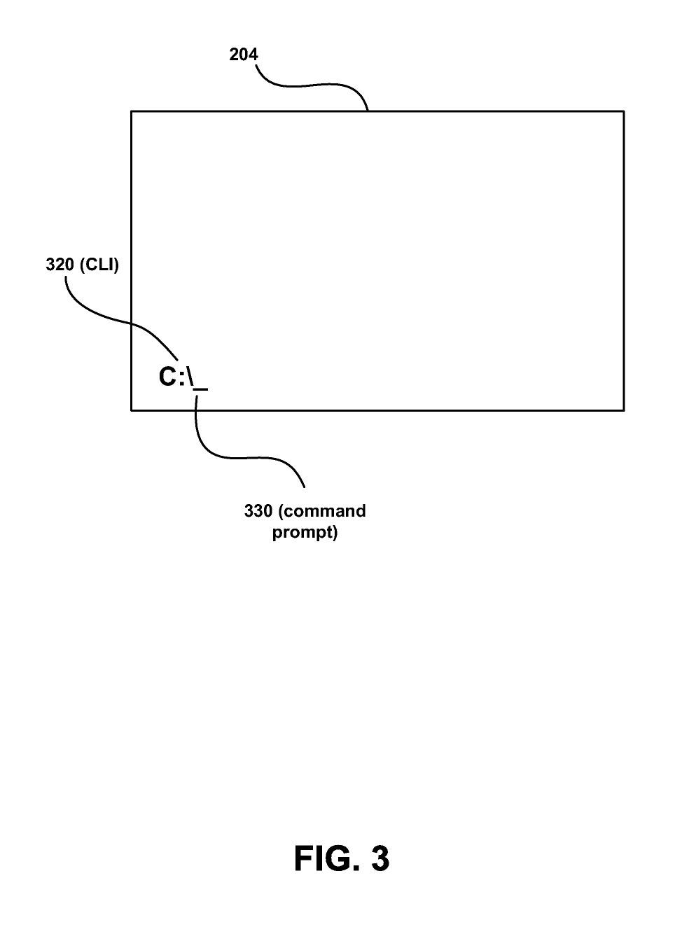

With reference to FIG. 3, display 204 displays CLI 320 associated with NCMI 270. At command prompt 330, a network administrator enters NCMI commands 272 that are mapped to associated HAMI commands 215. For example, the user enters a show ip command, at prompt 330, to determine the Internet Protocol Address for headless appliance 120. Accordingly, based on MICM 240, the network administrator is not required to switch to HAMI 210 and enter an ipconfig command to determine the Internet Protocol for headless appliance 120.

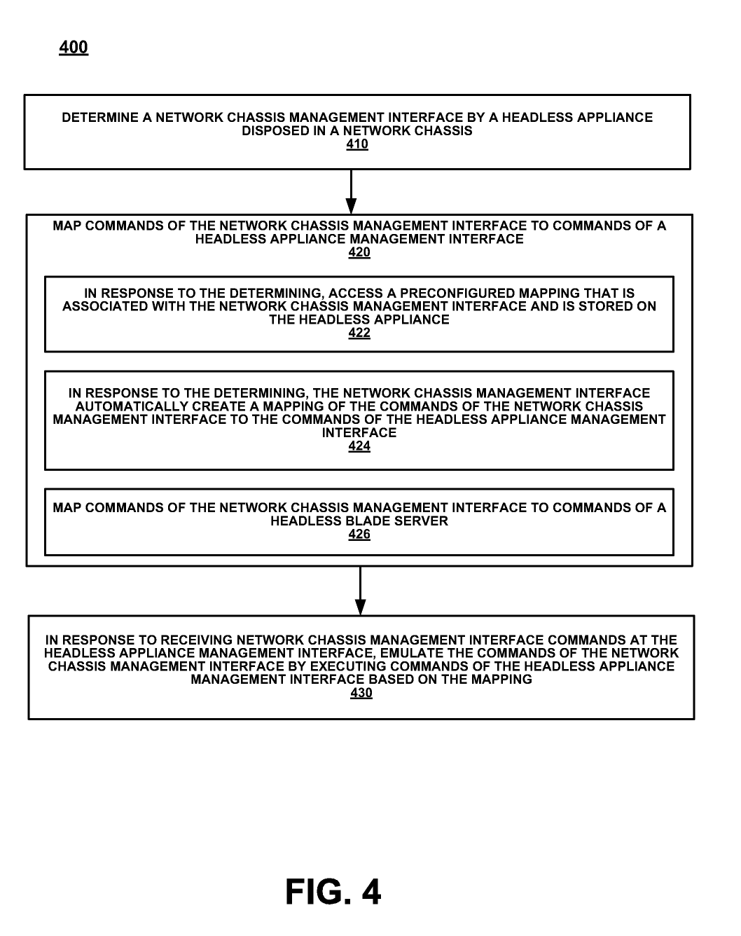

FIG. 4 depicts a method 400 for terminal emulation, in accordance with an embodiment of the present disclosure. In one embodiment, method 400 is carried out by processors and electrical components under the control of computer readable and computer executable instructions. The computer readable and computer executable instructions reside, for example, in a non-transitory computer readable data storage medium such as computer readable/usable volatile or non-volatile memory. However, the computer readable and computer executable instructions may reside in any type of computer readable storage medium. In some embodiments, method 400 is performed at least by headless appliance 120 described in FIGS. 1 and 2. In one such embodiment, the computer readable and executable instructions are thus carried out by a process and/or other components of headless appliance 120.

At 410, NCMI 270 is determined by a headless appliance 120 disposed in network chassis 110. As described, in one embodiment, this can be accomplished by NCMD 220 pinging network chassis 110 to determine the type of management interface that is resident upon network chassis 110. However, network chassis 110 may provide this information to headless appliance 120 in other manners, such as automatically in response to the coupling of headless appliance 120 with network chassis 110.

At 420, NCMI commands 215 are mapped to HAMI commands 215. For example, a show ip command is mapped to an ipconfig command.

In one embodiment, at 422, in response to the determining, a preconfigured MICM 240 that is associated with the NCMI 270 and stored on the headless appliance 120 is accessed. For example, a preconfigured mapping a Linux CLI commands to Microsoft Windows OS commands are stored on headless appliance 120 are accessed.

In another embodiment, at 424, in response to the determining, NCMI commands 272 are automatically mapped to HAMI commands 215. For example, DOS CLI commands of NCMI 270 are automatically mapped to HAMI commands 215 by AMIM 250.

In a further embodiment, at 426, NCMI commands 272 are mapped to commands of a headless blade server. For example, DOS CLI commands of NCMI 270 are mapped to commands of an x86 blade server.

At 430, in response to receiving NCMI commands 272 at HAMI 210, NCMI commands 272 are emulated by executing HAMI commands 215 based on MICM 240. For example, DOS CLI commands of NCMI 270 are emulated via emulator 260 by executing HAMI commands 215 based on a preconfigured mapping.

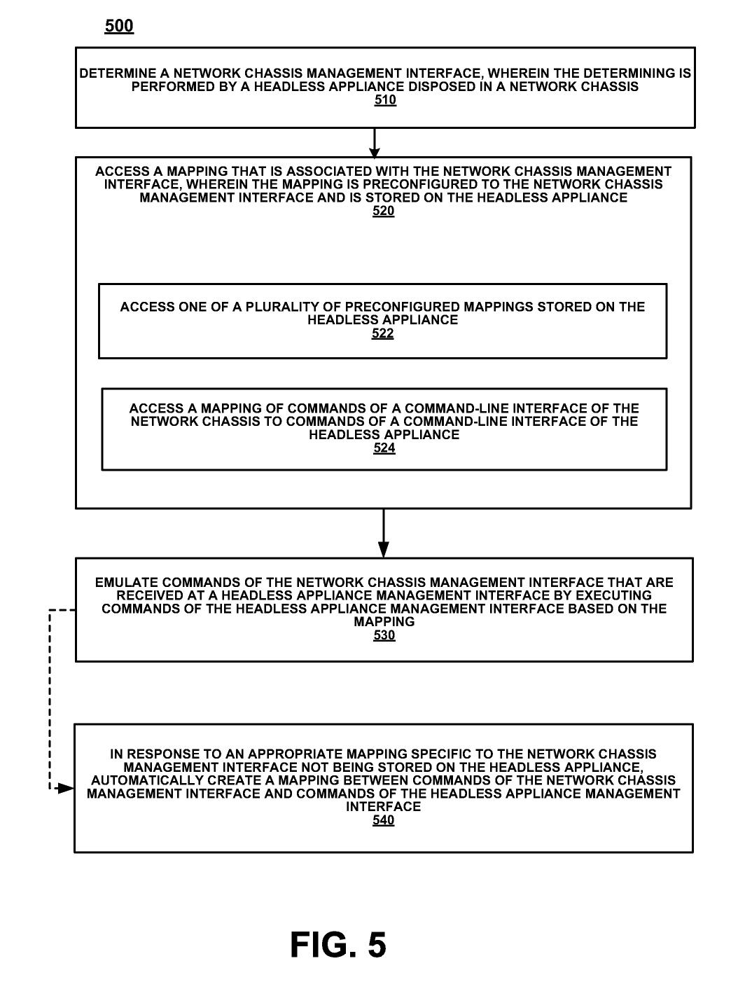

FIG. 5 depicts a method 500 for terminal emulation, in accordance with an embodiment of the present disclosure. In one embodiment, method 500 is carried out by processors and electrical components under the control of computer readable and computer executable instructions. The computer readable and computer executable instructions reside, for example, in a non-transitory computer readable data storage medium such as computer readable/usable volatile or non-volatile memory. However, the computer readable and computer executable instructions may reside in any type of computer readable storage medium. In some embodiments, method 400 is performed at least by headless appliance 120 described in FIGS. 1 and 2. In one such embodiment, the computer readable and executable instructions are thus carried out by a process and/or other components of headless appliance 120.

At 510, NCMI 270 is determined, wherein the determining is performed by a headless appliance 120 disposed in network chassis 110. As described, in one embodiment, this can be accomplished by NCMD 220 pinging network chassis 110 to determine the type of management interface that is resident upon network chassis 110. However, network chassis 110 may provide this information to headless appliance 120 in other manners, such as automatically in response to the coupling of headless appliance 120 with network chassis 110.

At 520, a mapping (e.g., MICM 240) that is associated with the NCMI 270 is accessed. The mapping is preconfigured to NCMI 270 and is stored on headless appliance 120. For example, the mapping is preconfigured to unix-like CLI of NCMI 270 and is stored on a non-transitory storage medium of headless appliance 120.

In one embodiment, at 522, one of a plurality of preconfigured mappings stored on headless appliance 120 is accessed. For example, the preconfigured mappings may be a mapping to a DOS CLI, Linux CLI, Networking device OS CLI, or the like.

In another embodiment, at 524, a mapping of commands of a CLI of network chassis 110 to commands of a CLI of headless appliance 120 is accessed. For example, a mapping of commands of CLI of network chassis 110 to dissimilar commands of a CLI of a headless blade server is accessed.

At 530, commands of the NCMI commands 272 that are received at HAMI 210 are emulated by executing HAMI commands 215 of HAMI 210 based on the mapping. For example, NCMI commands 272 are emulated by emulator 260, such that there is sense of cohesion between network chassis 110 and headless appliance 120 when a network administrator controls both network chassis 110 and headless appliance 120 via terminal 202

At 540, in response to an appropriate mapping specific to NCMI 270 not being stored on headless appliance 120, a mapping between NCMI commands 272 and HAMI commands 215 is automatically created. For example, AMIM 250 automatically generates MICM 240 in response headless appliance 120 not having a preconfigured MICM 240 in storage 230.

Various embodiments of the present disclosure are thus described. While the present disclosure has been described in particular embodiments, it should be appreciated that the present disclosure should not be construed as limited by such embodiments, but rather construed according to the following claims.

1. A headless appliance comprising:
a network chassis management interface determiner configured to determine a network chassis management interface, wherein said headless appliance is configured to be disposed in a network chassis; and
a management interface command mapping configured to associate commands of said network chassis management interface to commands of a headless appliance management interface.

2. The headless appliance of claim 1, wherein said headless appliance comprises:
a blade server.

3. The headless appliance of claim 1, wherein said management interface command mapping is preconfigured.

4. The headless appliance of claim 1, further comprising:
an automatic management interface mapper configured to automatically generate said management interface command mapping.

5. The headless appliance of claim 1, wherein said commands of said network chassis management interface are selected from a group consisting of: contextual commands, show commands, and negation commands.

6. The headless appliance of claim 1, wherein said headless appliance management interface is dissimilar from said network chassis management interface.

7. The headless appliance of claim 1, wherein said headless appliance management interface is selected from a group consisting of: DOS command-line interface and Linux command-line interface.

8. A computer-implemented method for terminal emulation, said method comprising:
determining a network chassis management interface by a headless appliance disposed in a network chassis;
mapping commands of said network chassis management interface to commands of a headless appliance management interface; and
in response to receiving network chassis management interface commands at said headless appliance management interface, emulating said commands of said network chassis management interface by executing commands of said headless appliance management interface based on said mapping.

9. The computer-implemented method of claim 8, wherein said mapping commands of said network chassis management interface to commands of a headless appliance management interface comprises:
in response to said determining, accessing a preconfigured mapping that is associated with said network chassis management interface and is stored on said headless appliance.

10. The computer-implemented method of claim 8, wherein said mapping commands of said network chassis management interface to commands of a headless appliance management interface comprises:
in response to determining said network chassis management interface, automatically creating a mapping of said commands of said network chassis management interface to said commands of said headless appliance management interface.

11. The computer-implemented method of claim 8, wherein said mapping commands of said network chassis management interface to commands of a headless appliance management interface comprises:
mapping commands of said network chassis management interface to commands of a headless blade server.

12. A computer-usable non-transitory storage medium having instructions embodied therein that when executed cause a computer system to perform a method for terminal emulation, said method comprising:
determining a network chassis management interface, wherein said determining is performed by a headless appliance disposed in a network chassis;
accessing a mapping that is associated with said network chassis management interface, wherein said mapping is preconfigured to said network chassis management interface and is stored on said headless appliance; and
emulating commands of said network chassis management interface that are received at a headless appliance management interface by executing commands of said headless appliance management interface based on said mapping.

13. The computer-usable non-transitory storage medium of claim 12, further comprising:
in response to an appropriate mapping specific to said network chassis management interface not being stored on said headless appliance, automatically creating a mapping between commands of said network chassis management interface and commands of said headless appliance management interface.

14. The computer-usable non-transitory storage medium of claim 12, wherein said accessing a mapping that is associated with said network chassis management interface, wherein said mapping is preconfigured to said network chassis management and is stored on said headless appliance comprises:
accessing one of a plurality of preconfigured mappings stored on said headless appliance.

15. The computer-usable non-transitory storage medium of claim 12, wherein said accessing a mapping that is associated with said network chassis management interface, wherein said mapping is preconfigured to said network chassis management and is stored on said headless appliance comprises:
accessing a mapping of commands of a command-line interface of said network chassis to commands of a command-line interface of said headless appliance.
